(19) United States
(12) Patent Application Publication
(10) Pub. No.: US 2017/0106642 A1
(43) Pub. Date: Apr. 20, 2017

(54) A PROCESS FOR PRODUCING A SECURITY FILM AND A SECURITY FILM

(71) Applicant: INNOVIA FILMS LIMITED, Wigton, Cumbria (GB)

(72) Inventors: Simon READ, Wigton, Cumbria (GB); Thierry GAVEL, Wigton, Cumbria (GB)

(21) Appl. No.: 15/307,270

(22) PCT Filed: Jun. 26, 2015
(86) PCT No.: PCT/IB2015/054817

§ 371 Date: Oct. 27, 2016

(30) Foreign Application Priority Data
Jun. 30, 2014 (GB) 1411623.0

(51) Int. Cl. B32B 38/00; B32B 37/20; B32B 37/12; B32B 7/12; B32B 15/20; B42D 25/47; B42D 25/29; B42D 25/21; B42D 25/328; B42D 25/364; B42D 25/373; B29C 65/00; B32B 27/18

(52) U.S. Cl. CPC B32B 38/0008; B29C 65/002; B29C 66/7422; B29C 66/74281; B32B 37/203; B32B 37/12; B32B 7/12; B32B 15/20; B32B 27/18; B42D 25/29; B42D 25/21; B42D 25/328; B42D 25/364; B42D 25/373; B42D 25/47; B32B 2310/14; B32B 2311/24; B32B 2311/12; B32B 2571/00; B29K 2105/256

(57) ABSTRACT

The invention concerns a process for producing a security film, comprising: forming a polymeric film substrate having first and second surfaces and comprising one or more migratory additives; plasma treating at least a part of at least one surface of the polymeric film substrate; and promptly contacting a foil with the at least one part of the plasma treated surface of the polymeric film substrate such that the foil adheres to the polymeric film substrate.

This application is a national stage application of International Patent Application No. PCT/IB2015/054817, filed Jun. 26, 2015, which claims priority to United Kingdom patent Application No. 1411623.0, filed Jun. 30, 2014. The entirety of the aforementioned applications is incorporated herein by reference.

### FIELD

The present invention is concerned with the surface treatment of substrates, particularly polymeric film substrates containing migratory additives, to clean the surface and improve adherence to other materials.

### BACKGROUND

Polymeric films are increasingly being used as substrates in fields where security, authentication, identification and anti-counterfeiting are important. Polymer-based products in such areas include, for example, bank notes, credit cards, important documents (e.g. ID materials including passports and land title, share and educational certificates), films for packaging high-value goods for anti-counterfeiting purposes, security labels and security cards.

Polymeric films have advantages in terms of security, functionality, durability, cost-effectiveness, cleanliness, processability and environmental considerations. Arguably the most notable amongst these is the security advantage. Paper-based bank notes, for example, can be relatively easy to copy, and there is higher occurrence of counterfeit bank notes in countries with paper-based bank notes compared to those countries using polymer-based bank notes. In addition, polymer-based bank notes are longer-lasting and less-easily torn than their paper-based counterparts.

Security materials based on polymeric films have the advantage that the high temperatures used in copying machines will often cause melting or distortion of polymer base materials if counterfeiters attempt simply to copy secure materials (e.g. bank notes) using such machines. In addition, security materials based on polymeric films are amenable to the incorporation of a variety of visible and hidden security features. Since the introduction of the first polymer bank notes, security features have included optically variable devices (OVDs), opacification features, printed security features, security threads, embossing, transparent windows and diffraction gratings.

Optically variable devices (OVDs) include holograms, diffraction grating images and/or liquid crystal technology, for example. They are typically formed from a foil containing iridescent images. The foil may exhibit various optical effects, for example movement or colour changes, according to the viewing angle. A major advantage of OVDs is that they cannot be accurately replicated or reproduced without using expensive, specialist equipment—simply photocopying or scanning the OVD will not work.

In general, the foil comprises a metallised layer, for example comprising copper or aluminium. The foil usually includes an adhesive layer provided on one surface of the metallised layer. Typically, prior to application, the foil is part of a laminate structure comprising a release film, for example a polyethylene terephthalate film. The laminate structure may be formed by depositing a metallised layer onto the release film and then applying an adhesive layer to the exposed surface of the metallised layer. The current practice is to use hot foil stamping or continuous foil application to adhere the foil to a polymeric film substrate. During this process, the release film detaches from the foil after adhesion of the foil to the substrate, leaving the foil adhered to the polymeric film substrate via the adhesive layer.

However, various problems exist when applying the foil to the polymeric film substrate. For example, it is difficult to achieve the necessary adhesion of the foil to the polymeric film substrate due to the often fundamentally different nature of the two components. The delicate nature of the security features combined with poor adhesion between the foil and the polymeric film substrate, often results in parts of the foil being pulled off the polymeric film substrate when the release film is detached or the foil failing a tape adhesion test. Consequently, there is a need in the art for a process whereby foils with different characteristics, for example different compositions, shapes and sizes, can be consistently adhered to a polymeric film substrate.

It is known in the art to plasma treat film substrates to improve their adherence to other materials.

For example, US 2004/031591 describes a method for producing a multi-layered film web by joining together at least film webs and/or at least one film web and at least one coating material, wherein that surface of the at least one film web which is brought into contact with another film web or with a coating material is treated with an indirect atmospheric plasmatron, with the optional addition of a working gas to the plasma generated by the plasmatron.

KR 922281 B1 describes a method for improving adhesion strength between a plastic resin and a metal film, wherein the plastic resin is treated with atmospheric pressure plasma so as to form holes with the size of 0.01 to 5 μm or embossing on the surface of the plastic resin.

KR 710909 B1 describes a method for modifying the surface of a PTFE film to increase the adhesion force between the surface of the PTFE film and a metal. The method involves positioning the PTFE film in a vacuum chamber, and maintaining the vacuum state; supplying oxygen gas into the vacuum chamber at a flow rate of 8 to 13 sccm; and forming oxygen plasma by irradiating hydrogen ion beams onto the surface of the PTFE.

Where the polymeric film substrate contains additives, particularly migratory additives, further problems are encountered when applying the foil to the polymeric film substrate. Migratory additives, for example slip promoting additives, anti-static additives and/or anti-block additives, are often added to polymeric film substrates to make handling of the film easier. However, these additives have a tendency to migrate to the surface of the polymeric film substrate. The rate and mode of migration of such additives is well researched, for example in J. Chen, J. Li, T, Hu and B. Walther, J. Vac. Sci. Technol., 2007, 25 (4), 886-892, it was found that the level of erucamide (a slip promoting additive) concentration at the surface of a low density polyethylene film reached near equilibrium within 2 hours of film production and a full coverage of erucamide at the film surface was near complete within 20 minutes of film production.

The surface chemistry of a polymeric film substrate may be significantly altered when migratory additives are present in the substrate. In particular, the ability of the polymeric film substrate to adhere to other materials, for example foils, may be reduced.

Plasma cleaning is a known process for removing surface contaminants from the surface of a substrate. The plasma activated atoms and ions break down the surface contaminants which are subsequently vaporised and removed from the plasma chamber. Plasma cleaning has numerous advantages over traditional wet chemical (solvent or aqueous) cleaning, for example hazardous solvents or acids are not required and the ‘waste’ products are harmless gases which can be released directly into the atmosphere without further treatment.

However, the prior art does not contemplate the problem of adhering a foil to a polymeric film substrate containing migratory additives, or offer any solutions thereto. Thus, there remains a need in the art for an improved process for adhering foil to a polymeric film substrate containing migratory additives.

### BRIEF DESCRIPTION OF THE DRAWINGS

FIG. 1 shows a graph of the adhesion score against power.

### DETAILED DESCRIPTION

According to a first aspect of the present invention, there is provided a process for producing a security film, comprising:
a. forming a polymeric film substrate having first and second surfaces and comprising one or more migratory additives;
b. plasma treating at least a part of at least one surface of the polymeric film substrate; and
c. promptly contacting a foil with the at least one part of the plasma treated surface of the polymeric film substrate such that the foil adheres to the polymeric film substrate.

By ‘security film’ we mean any film which may be used in a security application, including, but not limited to, bank notes, gift vouchers, credit cards, security packaging, security labels, important documents e.g. ID materials including passports and birth certificates, transport documents, and land title, share and educational certificates, and the like.

The plasma treatment in step b. may have the effect of removing one or more migratory additives from the at least one surface of the polymeric film substrate.

In this context, by ‘removing’ we mean reducing the quantity of one or more migratory additives from the at least one surface of the polymeric film substrate. In some scenarios, one or more migratory additives is substantially eliminated from the at least one surface of the polymeric film. Optionally, all of the migratory additives are substantially eliminated from the at least one surface of the polymeric film.

The plasma treating step b. may be carried out using one or more plasma torches, for example those manufactured by PlasmaTreat®, Raantec® or Tigres®. An advantage of using one or more plasma torches is that a precise part or parts of the at least one surface of the polymeric film substrate can be plasma treated. In particular, the precise part or parts of the at least one surface of the polymeric film substrate which is/are to contact and adhere to the foil, can be plasma treated. This may help to reduce manufacturing costs, since the entire surface of the polymeric film substrate does not necessarily have to be plasma treated.

Following the plasma treatment in step b., a foil is promptly contacted with the at least one part of the plasma treated surface of the polymeric film substrate such that the foil adheres to the polymeric film substrate, as outlined in step c.

By ‘promptly’ we preferably mean within seconds or minutes. For example, the foil may be contacted with the at least one part of the plasma treated surface of the polymeric film substrate in less than about 30 minutes, less than about 20 minutes, less than about 10 minutes, less than about 5 minutes, less than about 1 minute, less than about 30 seconds, less than about 20 seconds, less than about 10 seconds, less than about 5 seconds or less than about 2 seconds after the plasma treatment in step b.

The foil may be contacted with and adhered to the polymeric film substrate using any process known in the art, for example hot foil stamping, cold foil stamping, pressure adhesion or continuous stripe application. The preferred process is continuous stripe application. Continuous stripe application may be carried out using a continuous foil application machine, for example a continuous foil application machine manufactured by Kurz® e.g. Kurz® MHS or KBA OptiNota®, or Gietz®e.g. FSA 1060 Foil Commander. During continuous foil application, heat and pressure, may be used to adhere the foil to the polymeric film substrate. Any temperature suitable for adhering the foil to the polymeric film substrate may be used, provided that the polymeric film substrate is not substantially deteriorated, for example melted, during the continuous foil application process. For example, the temperature used in the continuous foil application process may be from about 50° C. to about 150° C., from about 70° C. to about 120° C., or from about 80° C. to about 110° C.

Where step c. is carried out using a hot foil stamp machine, one or more plasma torches may be positioned in-line with the hot foil stamp machine and/or integrated therewith. This enables the foil to be promptly contacted with the at least one part of the plasma treated surface of the polymeric film substrate and adhered thereto.

The plasma treatment in step b. may be atmospheric pressure plasma treatment. Additionally or alternatively, the atmospheric pressure plasma treatment may be a modified atmosphere plasma treatment i.e. a plasma treatment which takes place in a modified atmosphere rather than in air. Preferably, the modified atmosphere plasma treatment is modified atmosphere dielectric barrier discharge (MADBD) treatment.

The modified atmosphere of the MADBD treatment may comprise an inert carrier gas such as a noble gas, for example helium or argon, and/or nitrogen. Additionally or alternatively, the modified atmosphere of the MADBD treatment may comprise at least one of: one or more polar fluids with the capacity to form ionic or covalent bonds with the at least a part of at least one surface of the polymeric film substrate; one or more reducing fluids; and one or more oxidising fluids.

The one or more polar fluids with the capacity to form ionic or covalent bonds with the at least a part of the at least one surface of the polymeric film substrate may comprise ammonia and/or sulphur hexafluoride, for example.

The one or more reducing fluids may comprise acetylene, ethylene, hydrogen and/or silane, for example.

The one or more oxidising fluids may comprise oxygen, ozone, carbon dioxide, carbon monoxide, a nitric oxide, a nitrous oxide, sulphur oxide, sulphur dioxide and/or sulphur trioxide, for example.

It may be advantageous to include one or more oxidising fluids in the modified atmosphere since they may help to prevent the build-up of soot on the surface of the polymeric film substrate.

However, where one or more oxidising fluids are used, they should be present in an amount which is insufficient to deteriorate the surface of the polymeric film substrate. For example, the oxidising fluids may be present in the modified atmosphere in an amount of less than 40%, less than 30%, less than 25%, less than 20%, less than 15%, less than 10%, less than 5% or less than 1% by weight or by volume. In certain circumstances, the one or more oxidising fluids may be present in the modified atmosphere in an amount of less than 5000 ppm, less than 2500 ppm, less than 1000 ppm, less than 500 ppm, less than 200 ppm or less than 100 ppm.

More specifically, it may be preferable for any oxidising fluids which have a relative dielectric strength less than that of air, where present, to be in the modified atmosphere in the amounts listed above.

Dielectric strength is a measure of the maximum voltage difference that can be applied across a pure material without the material breaking down. At the voltage where the material breaks down, electrons are released from the material and ions and radicals are formed. Thus, the material becomes conductive i.e. it loses its insulating properties. The dielectric strength of gases may be expressed as a value relative to the dielectric strength of air. The following table shows the dielectric strength for various gases relative to air:

| | | Dielectric Strength |
|---|---|---|
| Gas | Formula | Relative to Air |
| Octafluorocyclobutane | C₄F₈ | 3.6 |
| 1,2-Dichlorotetrafluoroethane | CF₂ClCF₂Cl | 3.2 |
| Sulphur hexafluoride | SF₆ | 3 |
| Dichlorodifluoromethane | CF₂Cl₂ | 2.9 |
| Perfluorobutane | C₄F₁₀ | 2.6 |
| Perfluoropropane | C₃F₈ | 2.2 |
| Hexafluoroethane | C₂F₆ | 2.02 |
| Carbon monoxide | CO | 1.2 |
| Nitrogen | N₂ | 1.15 |
| Carbon tetrafluoride | CF₄ | 1.01 |
| Air | mixture | 1 |
| Ammonia | NH₃ | 1 |
| Carbon dioxide | CO₂ | 0.95 |
| Hydrogen sulphide | H₂S | 0.9 |
| Chlorine | Cl₂ | 0.85 |
| Oxygen | O₂ | 0.85 |
| Trifluoromethane | CF₃H | 0.8 |
| Hydrogen | H₂ | 0.65 |
| Sulphur dioxide | SO₂ | 0.3 |
| Argon | Ar | 0.2 |
| Neon | Ne | 0.02 |
| Nitrous oxide | N₂O | 1.3 |

During the plasma treatment in step b. the gases present in the modified atmosphere breakdown to give a mixture of ions, radicals, electrons etc.

As a general principle, gases with a lower dielectric strength are more reactive than gases with a higher dielectric strength, with the exception of the noble gases. Consequently, those gases with a lower dielectric strength may have a greater ability to react with the surface of the polymeric film substrate during the plasma treatment in step b.

Certain oxidising fluids with a relative dielectric strength less than that of air may react with the surface of the polymeric film substrate to the extent that the surface becomes damaged. Consequently, the ability of the polymeric film substrate to adhere to other materials, in particular foils, may be significantly reduced. Oxygen is a specific example of such an oxidising fluid. Without wishing to be bound by any such theory, it is believed that the oxygen ions/radicals formed during plasma treatment may cleave the backbone of the polymer molecules present at the surface of the polymeric film substrate. This may result in the surface of the polymeric film substrate breaking down and becoming oily, which may cause the polymeric film substrate to lose (or severely reduce) its ability to adhere to other materials, in particular foils.

The inventors of the present invention have surprisingly found that where the modified atmosphere comprises oxidising fluids with a relative dielectric strength less than that of air e.g. O₂, CO₂, SO₂, these are preferably present in the modified atmosphere in the amounts listed above, namely below 40% by weight or by volume. At this amount, it has unexpectedly been found that the oxidising fluids are able to beneficially functionalise the surface of the polymeric film substrate (as explained later) without substantially damaging it.

In one embodiment, the modified atmosphere comprises nitrogen and acetylene.

The surface chemistry of the polymeric filmic substrate may be affected by the plasma treatment in step b., in particular its functionality, for example the amount of polar chemical species present at the surface of the film. Prior to plasma treatment, the surface of the polymeric film substrate may, or may not, contain polar chemical species at its surface in any significant or substantial amount (above 1% relative atomic concentration for example). A polyolefin film, for example, essentially comprises only carbon-carbon and carbon-hydrogen bonds and is therefore substantially non-polar. On the other hand, a polyester film or an acrylic-coated film for example will already contain polar chemical species, including at its surface.

The precise nature of the chemical functionality engendered at the surface of the film by plasma treatment will depend upon many factors, including the chemical characteristics of the polymeric film substrate itself at its surface, the nature of the atmosphere provided during the plasma treatment, the power and duration of the plasma treatment and other ancillary parameters such as the environment, both physical and chemical, in which the polymeric film substrate is treated and/or maintained. Polar fragments may derive from the film itself and/or from the atmosphere in which the film is treated. In particular, polar fragments may derive from the atmosphere of the plasma treatment, alone or in combination with materials from the polymeric film substrate. For example, when the atmosphere of the plasma treatment comprises nitrogen gas, there will likely be polar fragments comprising carbon-nitrogen bonds at the film surface after plasma treatment.

The polar chemical species at the film surface after plasma treatment may comprise one or more of the species selected from: nitrile, amine, amide, hydroxy, ester, carbonyl, carboxyl, ether and oxirane.

The technique of ToF-SIMS spectroscopy has been found to be a satisfactory method for measuring in qualitative terms the surface functionality (in terms of the identities of polar species present at the surface) of the film. However, for quantitative characterisation (in terms of relative atomic concentration of polar species at the film surface), the inventors have found the technique of XPS spectroscopy to be more useful. Other determinative methods will be apparent to the skilled addressee.

The polymeric film substrate may be passed through any number of plasma treatment zones, for example plasma torch treatment zones, during the plasma treatment. For example, 1 to 10 plasma treatment zones may be used. Each plasma treatment zone may have the same or a different modified atmosphere comprising one or more of an inert carrier gas, an oxidising fluid, a reducing fluid and a polar fluid.

The inventors of the present invention have surprisingly found that plasma treatment of at least a part of at least one of the surfaces of the polymeric film substrate enhances foil adhesion thereto. The level of adhesion between the polymeric film substrate and the foil is able to pass the rigorous testing of security films e.g. bank notes. In particular, the level of adhesion between the polymeric film substrate and the foil is able to pass the rigorous tests outlined in ISO 9001, these include: chemical resistance tests, crumpling tests, abrasion tests, tearing resistance tests, lightfastness tests, washing machine tests, resistance to ironing tests and foil freezing tests. Due to the enhanced level of adhesion between the polymeric film substrate and the foil, it is possible to use conventional continuous foil application to effectively adhere the polymeric film substrate and the foil to one another, even when the security features and designs of the foil are delicate.

Without wishing to be bound by any such theory, it is believed that the surface of the polymeric film substrate is chemically altered during plasma treatment. In particular, the amount of polar chemical species on the film surface is increased. These polar chemical species may form strong interactions with the foil (particularly with an adhesive layer provided on the foil, where present), for example via hydrogen bonding or ionic bonding, which strongly adhere the polymeric film substrate to the foil.

The polymeric film substrate may comprise a polyolefin, for example polyethylene, polypropylene, polybutylene, mixtures, blends or copolymers (random or block) thereof and/or other known polyolefins. Additionally or alternatively, the polymeric film substrate may comprise a biopolymer, for example cellulose or derivatives thereof, carbohydrate-based polymers or lactic acid based polymers e.g. polylactic acid; a polyurethane; a polyvinylhalide; a polystyrene; a polyester; a polyamide; an acetate; and/or mixtures or blends thereof. Preferably, the polymeric film substrate comprises polypropylene, more preferably biaxially oriented polypropylene (BOPP).

The polymeric film substrate may be made by any process known in the art, including, but not limited to, cast sheet, cast film and blown film. The film may be prepared as a balanced film using substantially equal machine direction (MD) and transverse direction (TD) stretch ratios, or can be unbalanced, where the film is significantly more oriented in one direction (MD or TD). Sequential stretching can be used, in which heated rollers effect stretching of the film in the machine direction and a stenter oven is thereafter used to effect stretching in the transverse direction. Alternatively, simultaneous stretching, for example, using the so-called bubble process, or simultaneous draw stenter stretching may be used.

The polymeric film substrate may be mono-oriented in either the machine or transverse directions. Alternatively, the polymeric film substrate may be biaxially oriented.

The polymeric film substrate may be a mono-layer film, or it may be a multi-layer film. In the latter case, the film may comprise at least one core layer forming a substantial element of the films overall thickness. The multi-layer film may comprise one or more additional layers such as skin layers, coatings, co-extrudates, primer layers, overlaquers and the like.

The skin layers and/or coatings may independently be formed of or comprise a polyolefin material, such as polyethylene, polypropylene, polybutylene, mixtures, blends or copolymers thereof and/or other known polyolefins. Additionally or alternatively, the skin layers and/or coatings may be formed of or comprise a biopolymer, for example cellulose or derivatives thereof, carbohydrate-based polymers or lactic acid based polymers e.g. polylactic acid; a polyurethane; a polyvinylhalide; a polystyrene; a polyester; a polyamide; an acetate; and/or mixtures or blends thereof. The surface of the film substrate that is plasma treated preferably does not comprise an adhesive layer.

The skin layers and/or coatings may have a thickness of from about 0.05 μm to about 5 μm, from about 0.1 μm to about 3 μm, from about 0.2 μm to about 2 μm or from about 0.3 μm to about 1 μm.

The total thickness of the polymeric film substrate may vary depending on the application requirements. For example, the polymeric film substrate may have a thickness of from any one of 1 μm, 5 μm, 10 μm, 15 μm, 20 μm or 30 μm; to any one of 50 μm, 70 μm, 80 μm, 100 μm, 120 μm, 200 μm or 350 μm.

The polymeric film substrate comprises one or more migratory additives. By ‘migratory additives’ we mean those additives which have a tendency to migrate to the surface of a film, causing surface contamination. The migratory additives present in the polymeric film substrate may comprise one or more of slip promoting additives, anti-static additives and anti-block additives, for example erucamide, calcium stearate and/or glycerol monostearate.

Immediately prior to plasma treatment in step b), the polymeric film substrate may comprise one or more migratory additives at the at least one surface of the polymeric film substrate. The one or more migratory additives may be present at the at least one surface of the polymeric film substrate in an amount of x ppm immediately prior to plasma treatment in step b). Following plasma treatment in step b), the one or more migratory additives may be present at the at least one surface of the polymeric film substrate in an amount of y ppm, y being less than x.

It might be thought that the presence of such migratory additives on the surface of the polymeric film substrate would prevent the plasma treatment from beneficially affecting the film surface. However, it has surprisingly been found that this is not the case.

Rather, the inventors of the present invention have unexpectedly found that polymeric film substrates comprising one or more migratory additives, such as slip promoting additives, anti-static additives and/or anti-block additives, have an enhanced ability to adhere to foils following plasma treatment.

Without wishing to be bound by any such theory, the inventors believe that the plasma treatment has a dual function when used to treat polymeric film substrates comprising one or more migratory additives.

Firstly, the plasma treatment is believed to clean the surface of the polymeric film substrate i.e. substantially remove any migratory additives at the surface of the film. It is believed that the activated species present in the plasma are able to break down the migratory additives at the surface of the polymeric film substrate, for example through oxidation of the additives to form carbon dioxide, water vapour, carbon monoxide etc. The migratory additives are thus vaporised and removed from the surface of the polymeric film substrate.

Secondly, the plasma treatment is believed to chemically alter the surface of the polymeric film substrate as previously outlined, which enhances the ability of the polymeric film substrate to adhere to a foil.

The inventors have found that good adhesion between the foil and the polymeric film substrate can be realised when the foil is promptly contacted with the at least one part of the plasma treated surface of the polymeric film substrate. It is believed that the migratory additives contained within the polymeric film substrate do not have enough time to migrate to the surface between plasma treatment and adhesion with the foil.

The foil may comprise a metal foil layer. The metal foil layer may be a metallised layer or a metal foil layer as commonly understood in the art i.e. a thin sheet of metal usually formed by hammering or rolling a piece of metal. The metal foil layer may comprise copper or aluminium for example. Alternatively, the foil may comprise a non-metallic foil layer, for example Kurz® Transparent KINEGRAM® Overlay (TKO). Additionally, the foil may comprise an adhesive layer on at least one surface of the metal or non-metal foil layer. The adhesive layer may comprise any suitable adhesive known in the art. For example, the adhesive layer may comprise one or more of an acrylic, a urethane, an amine, an amide, an acrylate and an acetate, and/or polymers thereof. The foil may also comprise a cover layer, an embossed layer, a protection layer and/or a release layer. A preferred structure of a foil according to the present invention is: carrier film (such as a biaxially orientated polyester film)/release layer/protection layer/embossed layer/metalised layer/cover layer/hot melt adhesive.

Prior to use, the foil may be part of a laminate structure comprising a release film, for example a polyethylene terephthalate film. Where the foil comprises a metallised layer, the laminate structure may be formed by depositing a metallised layer onto the release film, for example using a standard vacuum metallising process. An adhesive layer may then be applied to the exposed surface of the metallised layer.

The foil may be an optically variable device (OVD), a cold foil, a hot stamping foil and/or any suitable foil manufactured by Kurz®, for example Luxor®, Alufin®, Light Line® or SECOBO®.

The OVD may be, for example, a hologram, a diffraction grating image or comprising liquid crystal technology. The OVD may comprise iridescent images, which exhibit various optical effects, for example movement or colour changes, according to the viewing angle.

The process may comprise the additional steps of opacification, embossing, etching, printing and/or overcoating of the polymeric film substrate. Steps b. and c. may be carried out prior to or after one or more of any such additional steps. Preferably, steps b. and c. are carried out after any such additional steps.

Printing of the polymeric film substrate may be carried out by any known process in art, for example, UV Flexo, screen or combination printing, gravure or reverse gravure printing, traditional offset printing, intaglio printing or letterpress printing.

According to a second aspect of the present invention, there is provided a security film obtained or obtainable by means of the process previously outlined.

According to a third aspect of the present invention, there is provided a security document or article comprising the film of the second aspect of the invention.

According to a fourth aspect of the present invention, there is provided a security film comprising a polymeric film substrate having at least one surface comprising functional groups capable of adhering to a foil and comprising one or more migratory additives, wherein the functional groups are inducible on the film surface by means of plasma treatment.

According to a fifth aspect of the present invention, there is provided a security film comprising a polymeric film substrate having a first and second surface and comprising therein one or more migratory additives, the one or more migratory additives being distributed through the polymeric film substrate but being substantially absent from at least one of the first and second surfaces, the film comprising an adhered foil in a region of the at least one first or second surface which is substantially absent any migratory additives.

The distribution of the one or more migratory additives in the polymeric film substrate may be homogeneous or inhomogeneous.

The distribution profile of the one or more migratory additives may change over time. However, migration of the one or more migratory additives at or towards at least one first or second surface may be ineffective to detach the adhered foil.

By way of explanation, after manufacture of the security film, the migratory additives may continue to migrate towards at least one first or second surface of the polymeric film substrate. However, the security film comprises an adhered foil in a region of the at least one first or second surface which is substantially absent any migratory additives, thus, the further migration of the additives towards at least one first or second surface of the polymeric film substrate will be ineffective to detach the adhered foil.

For the avoidance of doubt, all features of the first aspect of the invention may apply to the second, third, fourth and fifth aspects of the invention and vice versa.

The invention is further described by way of the following examples, which are by way of illustration only, and are not limiting to the scope of the invention described herein.

### EXAMPLES

A biaxially oriented polymeric film having a core layer of clear polypropylene and coextruded skin layers of a polypropylene copolymer is manufactured by means of a bubble process. The film has a total thickness of 50 μm, with each of the skin layers having an approximate thickness of 0.5 μm. The core layer of the film contains the migratory additives: erucamide, calcium stearate and glycerol monostearate.

Eight samples (1 to 8) of the polymeric film substrate are subjected to MADBD treatment using a plasma torch in a specific region on the surface, namely a strip, under the conditions outlined in Table 1. The polymeric film substrate is passed through four plasma torch treatment zones during MADBD treatment. For samples 1, 2 and 4 to 8, each of the plasma treatment zones has the same modified atmosphere composed of the components shown in the table. However, for Sample 3, the first plasma torch treatment zone has a modified atmosphere composed of nitrogen only and the remaining plasma torch treatment zones have a modified atmosphere composed of all the components shown in the table.

Sample 0 forms the control experiment and was not subjected to MADBD treatment.

TABLE 1

| | | Modified Atmosphere | | | | |
|---|---|---|---|---|---|---|
| | Power | N₂ | N₂O | C₂H₂ | Gap | Speed |
| Sample | (W · m²/min) | (165 Nm³/h) | (ppm) | (ppm) | (Shims) | (m/min) |
| 1 | 65 | Yes | — | — | 2 | 275 |
| 2 | 65 | Yes | 1000 | — | 2 | 275 |
| 3 | 65 | Yes | 500 | 500 | 2 | 275 |
| 4 | 25 | Yes | 500 | 500 | 2 | 275 |
| 5 | 45 | Yes | 500 | 500 | 2 | 275 |
| 6 | 65 | Yes | 500 | 500 | 2 | 275 |
| 7 | 85 | Yes | 500 | 500 | 2 | 275 |
| 8 | 100 | Yes | 500 | 500 | 2 | 200 |

For each of the samples 1 to 8, a foil strip is contacted with the polymeric film substrate in the plasma treated region immediately following MADBD treatment, and is adhered thereto using a foil applicator. Similarly, a foil strip is contacted with the untreated polymeric film substrate of sample 0 and adhered thereto using hot foil stamping. The foil strip is formed of an aluminium layer with an amine-based adhesive layer on one side thereof. Prior to application, the foil strip has a polyethylene terephthalate release film provided on the opposite side of the aluminium layer to the adhesive layer. The foil strip is applied to the polymeric film samples using a Kurz® MHS of KB A OptiNota® hot foil stamp machine at a speed of 60 m/min and a foiling temperature of 95° C.

Following continuous foil application, the adhesion between the polymeric film substrate and the foil strip is tested. The test involves applying a strip of Tesa® tape over the foil strip on the polymeric film substrate and then pulling the tape off at an angle of 45°. The samples are then scored on a scale of 1 to 10. A score of 1 indicating that 100% of the foil strip is removed from the polymeric film substrate and a score of 10 indicating that 0% of the foil strip is removed. The results are shown in Table 2 below.

TABLE 2

| Sample | Adhesion Score |
|---|---|
| 0 | 1 |
| 1 | 4 |
| 2 | 3 |
| 3 | 9 |
| 4 | 5 |
| 5 | 7 |
| 6 | 9 |
| 7 | 9 |
| 8 | 8 |

From the results it can be seen that samples 1 to 8 which are MADBD treated, all show better adhesion between the foil strip and the polymeric film substrate compared to the control sample. This may provide evidence that the MADBD plasma treatment is effectively cleaning the surface of the polymeric film substrate i.e. substantially removing any migratory additives at the surface of the polymeric film substrate, and enhancing the adhesive ability of the substrate to the foil strip.

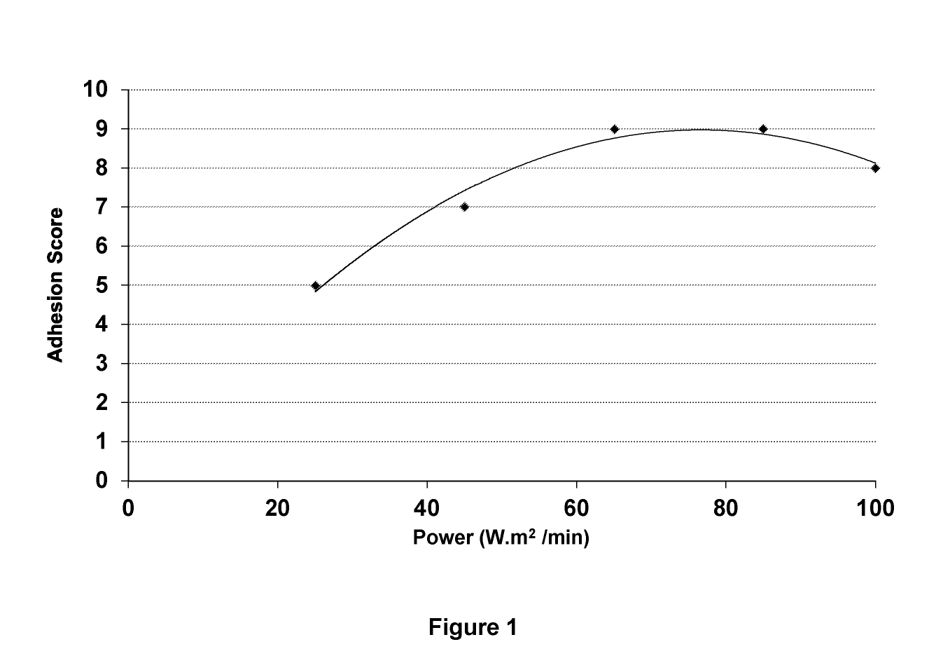

FIG. 1 shows a graph of the adhesion score against power. From the results, it can be seen that the preferred power range for MADBD treatment may be between about 60 and 90 W·m²/min.

1. A process for producing a security film, comprising:
a) forming a polymeric film substrate having first and second surface and comprising one or more minatory additives;
b) plasma treating at least a part of at least one surface of the polymeric film substrate; and
c) promptly contacting a foil with the at least part of the plasma treated surface of the polymeric film substrate such that the foil adheres to the polymeric film substrate.

2. The process according to claim 1, wherein the plasma treatment has the effect of removing one or more migratory additives from the at least one surface of the polymeric film substrate.

3. The process according to claim 1, wherein the foil is contacted with the at least one part of the plasma treated surface of the polymeric film substrate in less than about 30 minutes, less than about 20 minutes, less than about 10 minutes, less than about 5 minutes, less than about 1 minute, less than about 30 seconds less than about 20 second less than about. 10 seconds, less than about 5 seconds or less than about 2 seconds after the plasma treatment in step b.

4. The process according to claim 1, wherein the plasma treating step b is carried out using one or more plasma torches.

5. The process according to claim 4, wherein the one or more plasma torches are used to plasma treat a precise part or parts of the at least one surface of the polymeric film substrate which is/are to fee contacted and adhered to the foil.

6. The process according to claim 1, wherein step e is carried out using a foil applicator.

7. The process according to claim 6, wherein the foil application involves an increased temperature and a dwell times and as increased pressure.

8. The process according to claim 7, wherein the temperature during foil application is:
a) from about 50° C. to about 150° C.;
b) from about 70° C. to about 120° C.; or
c) from about 80° C. to about 110° C.

9. The process according to claim 1, wherein the plasma treating step b is carried out using an atmospheric pressure plasma treatment, optionally a Modified atmosphere plasma treatment.

10. The process according to claim 9, wherein the modified atmosphere plasma treatment is MADBD treatment.

11. The process according to claim 10, wherein the modified atmosphere of the MADBD treatment comprises at least one of:
a) an inert carrier gas;
b) one or more polar fluids;
c) one or more reducing fluids; and
d) one or more oxidising fluids,
e) one or more oxidising fluids.

12. The process according to claim 11, wherein the one or more oxidising fluids are present in the modified atmosphere in an amount of less 40%, less than 35%, less than 25%, less than 20%, less than 15%, less than 10%, less than 5% or less than 1% by weight or by volume, optionally less than 5000 ppm, less than 2500 ppm, less than 1000 ppm, less than 500 ppm, less than 200 ppm, or less than 100 ppm.

13. The process according to claim 1, wherein the polymeric film substrate comprises a polyolefin, a biopolymer; a polyurethane; a polyvinylhalide; a polystyrene; a polyester, a polyamide; an acetate; and/or mixtures or blends thereof.

14. The process according to claim 13, wherein the polyolefin is selected from polyethylene, polypropylene, polybutylene, mixtures blends or copolymers thereof.

15. The process according to claim 14, wherein the polypropylene is biaxially oriented polypropylene.

16. The process according to claim 1, wherein the polymeric film substrate comprises one or more skin layers and/or coatings.

17. The process according to claim 16, wherein the one or more skin layers and/or coatings comprise a polyolefin material; a polyurethane; a polyvinylhalide; a polystyrene; a polyester; a polyamide; an acetate; and/or mixtures or blends thereof.

18. The process according to claim 16, wherein the one or more skin layers and/or coatings have a thickness of:
a) from about 0.05 μm to about 5 μm;
b) from about 0.1 μm to about 3 μm;
c) from about 0.2 μm to about 2 μm; or
d) from about 0.3 μm to about 1 μm.

19. The process according to claim 1, wherein the total thickness of the polymeric film substrate is from any one of 1 μm, 5 μm, 10 μm, 15 μm, 20 μm or 30 μm; to any one of 50 μm, 70 μm, 80 μm, 90 μm, 100 μm, 120 μm, 200 μm or 350 μm.

20. The process according to claim 1, wherein the one or more migratory additives comprise one or more of slip promoting additives, anti-static additives and anti-block additives.

21. The process according to claim 20, wherein the one or more migratory additives comprise erucamide, calcium stearate acid/or glycerol monostearate.

22. The process according to claim 1, wherein immediately prior to step b the polymeric film substrate comprises one or more migratory additives at the at least one surface of the polymeric film substrate.

23. The process according to claim 22, wherein the one or more migratory additives are present at the at least one surface of the polymeric film substrate in an amount of x ppm immediately prior to step b.

24. The process according to claim 23, wherein the one or more migratory additives are present at the at least one surface of the polymeric film substrate in an amount of y ppm after step b, y being less than x.

25. The process according to claim 1, wherein following step b the treated part of the surface of the polymeric film substrate is substantially free from migratory additives.

26. The process according to claim 1, wherein the film comprises a metal foil layer, optionally wherein the metal foil layer is a metallised layer.

27. The process according to claim 26, wherein the metal foil layer comprises copper or aluminium.

28. The process according to claim 1, wherein the foil comprises a non-metallic foil layer.

29. The process according to claim 26, wherein the foil additionally comprises an adhesive layer on at least one surface of the metal or non-metal foil layer, optionally wherein the adhesive layer comprises one or more of an acrylic, a urethane, an amine, an amide, an acrylate and an acetate, and/or polymers thereof.

30. The process according to claim 1, wherein the foil is an optically variable device, a cold foil, a hot stamping foil and/or any suitable foil manufactured by Kurz®, in particular Luxor®, Alufin®, Light Line® or SECOBO®.

31. The process according to claim 1, wherein the process comprises one or more of the following additional steps; opacification, embossing, etching, printing and overcoating of the polymeric film substrate.

32. The process according to claim 31, wherein the process steps b and c are carried out after any such additional steps.

33. A security film obtained or obtainable by means of the process of claim 1.

34. A security document or article comprising the security film of claim 33.

35. A security film comprising a polymeric film substrate comprising one or more migratory additives and having at least one surface comprising functional groups capable of adhering to a foil, wherein the functional groups are inducible on the film surface by means of plasma treatment.

36. The security film according to claim 35, wherein the plasma treatment is MADBD treatment.

37. The security film according to claim 35, wherein the plasma treatment is provided by one or more plasma torches.

38. A security film comprising a polymeric film substrate having a first and second surface and comprising therein one or more migratory additives, the one or more migratory additives being distributed through the polymeric film substrate but being substantially absent from at least one of the first and second surfaces, the film comprising an adhered foil in a region of the at least one first or second surface which is substantially absent any migratory additives.

39. The security film according to claim 38, wherein the distribution of the one or more migratory additives in the polymeric film substrate is homogeneous or inhomogeneous.

40. The security film according to claim 38, wherein distribution profile of the one or more migratory additives changes over time, but wherein migration of the one or more migratory additives at or towards at least one first or second surface is ineffective to detach the adhered foil.
